(19) United States
(12) Patent Application Publication
(10) Pub. No.: US 2014/0053674 A1
(43) Pub. Date: Feb. 27, 2014

(54) SHIFT-BY-WIRE GEARSHIFT DEVICE FOR AN AUTOMATIC VEHICLE TRANSMISSION

(71) Applicants: Raul BRAVO DOMÍNGUEZ, Sant Cugat Del Valles (ES); Sergio Estevez Alvarez, Barcelona (ES)

(72) Inventors: Raul BRAVO DOMÍNGUEZ, Sant Cugat Del Valles (ES); Sergio Estevez Alvarez, Barcelona (ES)

(73) Assignee: FICO TRIAD, S.A., Viladecavalls (ES)

(21) Appl. No.: 13/592,334

(22) Filed: Aug. 22, 2012

(51) Int. Cl. B60K 20/02

(52) U.S. Cl. 74/473.12

(57) ABSTRACT

A pivotable selector lever assembly for performing shifting operations (P, R, N, D) for controlling a vehicle transmission. This may include an electronic transmission device linked to the selector lever assembly for determining the shifting operations, and a mechanical transmission device linked to the selector lever assembly and the vehicle transmission for mechanically performing at least one of the shifting operations. The mechanical transmission device may include a driving lever linked to the vehicle transmission and to the selector lever assembly. In a first travel of the selector lever assembly the driving lever is adapted to perform the at least one shifting operation when the selector lever assembly is actuated, and in a second travel the driving lever does not perform said at least one shifting operation while allowing the remainder shifting operations to be performed.

### TECHNICAL FIELD

A shift-by-wire gearshift device for an automatic vehicle transmission is disclosed herein.

### BACKGROUND

Vehicle transmission systems in motor vehicles are increasingly provided with electronic control for controlling shifting operations. An electronic controller typically receives electric signals generated by the movement of the shift lever each time it is operated by the user for performing shifting operations. These signals are processed by a control unit and sent to the vehicle gear transmission for driving the gear box.

It has been shown that an entirely electronically controlled gear shifter may become undesirably expensive. An electric starter motor strong enough to move the gears in certain conditions such as when the vehicle is parked on a steep hill may be required. This renders the assembly capital intensive. In other circumstances, for example, additional actuators for gear shifting could be necessary e.g. if power failure occurs. For example, if the vehicle transmission is in the park shifting position and there is a power failure, an additional actuator for gear shifting is necessary to move the transmission out of the park position. Again, this undesirably increases the overall cost of the assembly.

Solutions have been provided in the art for actively engaging and disengaging the parking brake in shift by wire gearshift devices through the use of mechanical arrangements. One example of such mechanical arrangements is a cable provided between the shifting device and the vehicle transmission and connected to the selector lever. The shift commands are transmitted electrically. The cable is connected to the selector lever so it is moved by the selector lever during each shifting movement between all shift commands.

However, the cable is always moved when performing shifting operations even those in which the parking brake mechanism is not actuated. Therefore, the cable, which is only for actuating the parking brake mechanism, is moved along relative large distances for engaging and disengaging the parking brake. This leads to friction generated during the unnecessary movement of the cable and the manual action of the selector lever does not result in a free and efficient movement thereof.

Document U.S. Pat. No. 7,322,457 provides a solution in which the cable activates the parking brake exclusively and automatically when the selector lever is engaged in the park shifting position. The selector lever is automatically uncoupled from the selector lever when the selector lever is pivoted beyond the adjacent position. This is achieved through the use of a multiple hinge configuration comprising two hinge pieces connected to each other and to a shifter frame and to a slider that is attached to the cable. Although with this solution the parking brake can be engaged and disengaged under all circumstances, the cinematic structure used involves complexity due to the undesirable large number of parts involved.

Accordingly, a simple end efficient transmission shifter capable of electronic actuation while being also capable of cable actuation for some gear shifting operations such as park P and reverse R is described.

### SUMMARY

A shift-by-wire gearshift device for an automatic vehicle transmission is disclosed herein. Advantageous embodiments are disclosed.

As stated herein, the shifting positions refer to the several different gear shift positions that can be selected by the user or driver by actuating a selector lever, such as for example park P, reverse R, neutral N and drive D. Other shifting positions are not ruled out according to requirements. Shifting operations will therefore result when going from one shifting position to another different shifting position, for example from P to R and vice versa.

In one implementation, a shift-by-wire gearshift device for an automatic vehicle transmission includes a housing for receiving a selector lever assembly and related parts. The gearshift device further includes a selector lever assembly that is designed for manually performing shifting operations for controlling the vehicle transmission. The selector lever is adapted to be mounted pivotable about at least one shift axis in the housing. In one embodiment, the selector lever is mounted to the housing such that it can be pivoted about two shift axes.

The device further comprises an electronic transmission device for transmitting shift commands to the vehicle transmission according to the shifting operations. Command signals are generated from said shift commands as the selector lever is moved by the user, i.e., pivoted relative to the housing.

The present-by-wire gearshift device is also provided with a mechanical transmission device. The mechanical transmission device is linked to the selector lever assembly, for example to the selector lever. This link allows the selector lever assembly to mechanically perform at least one of the shifting operations from the selector lever assembly to the vehicle transmission. Said at least one of the shifting operations may be, for example, shifting into the park position P for locking the vehicle transmission. Other shifting operations such as neutral N, drive D, manual mode M, reverse R, tip-up, tip-down, etc. are performed electrically through the selector lever while the mechanical transmission device is not actuated.

More specifically, the mechanical transmission device comprises a driving lever. In some embodiments, the driving lever may comprise a plate made of a single piece. The driving lever has a first end that is linked to the vehicle transmission and a second end that is linked to the selector lever assembly.

The driving lever is configured such that at least two different travels can be performed by the selector lever assembly when the selector lever is actuated by the user. In a first travel of the selector lever assembly, the driving lever is capable of operatively performing said at least one of the shifting operation when the selector lever assembly is actuated. In a second travel of the selector lever assembly, the driving lever does not perform said at least one shifting operation when the selector lever assembly is actuated while allowing the remaining shifting operations to be performed.

The second end of the driving lever includes a shaped groove. The selector lever assembly includes a pin protruding outwards. The pin of the selector lever assembly may be formed integrally with the lever assembly or it may be provided as a separate part.

The shaped groove of the driving lever is sized and shaped for receiving said pin formed in the selector lever assembly. The pin of the selector lever assembly is allowed to be moved along the shaped groove when inserted therein. The shaped groove of the driving lever has two different sections which, in one embodiment, are arranged inclined to each other. Therefore, a first section and a second section are defined in the shaped groove. The first section is arranged such that the driving lever is capable of operatively performing said at least one shifting operation when the selector lever is actuated by the user. The second section of the shaped groove is arranged such that the driving lever is not capable of performing the at least one shifting operation, e.g. the park position, while allowing the remaining shifting operations to be performed.

Alternatively, the driving lever could be provided with a pin and the selector lever assembly could be provided with a shaped groove suitable for receiving the pin of the driving lever. Likewise, the shaped groove would be adapted such that the pin can be moved therethrough and would have the first and second sections shaped such that the driving lever is capable of operatively performing said at least one shifting operation or not depending on the relative position of the driving lever.

The first end of the driving lever may be linked to the vehicle transmission, for example it may be connected to the parking brake mechanism. This may be carried out, for example, via a cable such as push-pull cable. In this case, the first end of the driving lever may be pivotally attached to one end of the cable. This arrangement allows said at least one shifting operation to be mechanically performed.

A housing may be also provided having at least two shift axes. In some embodiments of the present gearshift device, the two axes of the housing are arranged perpendicular to each other. As it will explained further below, this allows the lever assembly to be pivotally moved according to different modes of operation.

The selector lever assembly comprises a selector lever and a bracket. The bracket may be pivotally mounted to the housing such that it may be pivoted about at least one of the above mentioned shift axes of the housing. The selector lever is attached to the bracket by any suitable means. Alternatively, the selector lever could be formed integral with the bracket.

Actuation of the selector lever assembly causes rotation of the driving lever as the pin of the bracket is moved inside the first section of the shaped groove. This in turn results in that the cable is moved a required travel distance for performing said at least one shifting operation, such as for example, shifting into the park position P for locking the vehicle transmission. After this, the device is capable of electronically perform other shifting operations.

With the above structure, it has been found that a simple and robust shift-by-wire gearshift device obtained. The present gearshift device can be manufactured using fewer parts as compared with prior art gearshift devices, while providing high quality in shifting. This involves a significant reduction of tooling leading to a cost effective global device, less weight and so forth.

Additional objects, advantages and features of embodiments of the present gearshift device will become apparent to those skilled in the art upon examination of the description, or may be learned by practice of the device as disclosed herein.

### BRIEF DESCRIPTION OF THE DRAWINGS

Particular embodiments of the present gear-shift device will be described in the following by way of non-limiting examples, with reference to the appended drawings.

In the drawings:

FIG. 1 is a general perspective view corresponding to one embodiment of the present gear shift device shown in park shifting position (P); and

FIGS. 2 and 3 are elevational views corresponding to the embodiment of the gear-shift device depicted in FIG. 1, but with the housing removed, showing the relative positions of the selector lever, the push pull cable and the mechanical transmission device in park shifting position (P) and reverse shifting position (R), respectively.

### DETAILED DESCRIPTION OF EMBODIMENTS

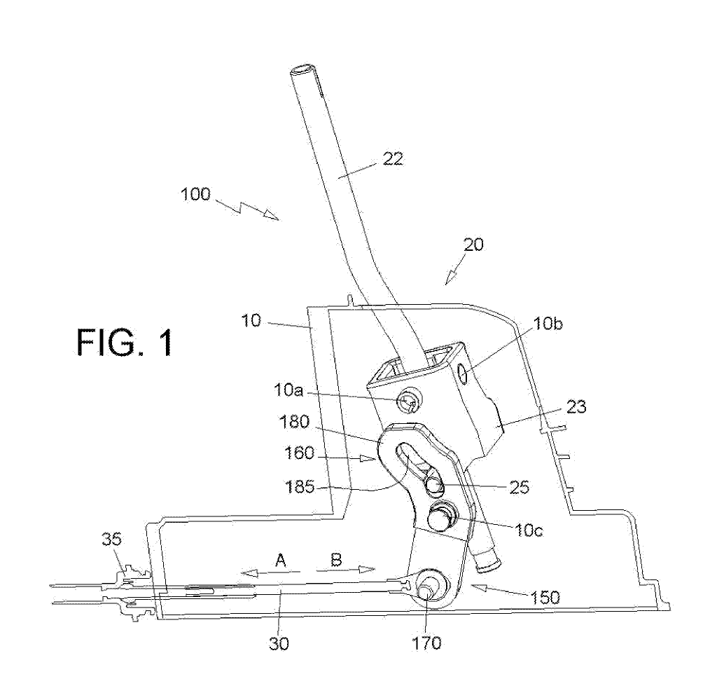

The embodiment of the shift-by-wire gearshift device 100 shown in the FIGS. 1-3 is intended for an automatic vehicle transmission. As shown in FIG. 1, the gearshift device 100 includes a housing 10. Within the housing 10, a selector lever assembly 20 can be pivoted when actuated by the user or driver. The selector lever assembly 20 has two shift axes 10a, 10b. One or both axes 10a, 10b of the selector lever assembly 20 may be protrusions formed perpendicular to each other and integral with the selector lever assembly 20. In an alternative embodiment, at least one of the axes 10a, 10b of the selector lever assembly 20 may be separate parts attached thereto.

The selector lever assembly 20 of the gearshift device 100 includes a selector lever 22 and a bracket 23. The selector lever 22 is attached to the bracket 23 by any suitable means. The selector lever 22 is designed for manually performing shifting operations such as shifting into park P, reverse R, neutral N and drive D gear shifting positions, or vice versa. The shift lever assembly 20, and particularly the selector lever 22, is pivotally mounted on the housing 10 through the above mentioned axes 10a, 10b. The axes 10a, 10b may be formed, for example, in the bracket 23. Therefore, the selector lever 22 can be pivoted within the housing 10 about the shift axes 10a, 10b of the bracket 23 such as in the embodiment shown. This means that, in this case, the selector lever 22 can be pivoted back and forth and side to side relative to vehicle running (for example, for Triptronic operation in M+, M− positions). This allows different shifting modes to be performed by the selector lever assembly 20 such as normal mode and cable actuation mode.

The gearshift device 100 in the particular embodiment shown further includes an electronic transmission device suitable for electronically performing shifting operations. Command signals are generated in correspondence with the movement of the selector lever 22 when actuated by the user or driver.

A mechanical transmission device 150 is also provided. The mechanical transmission device 150 includes a driving lever 160. In the embodiment shown in the figures, driving lever 160 may be a plate made of a single piece having a first end 170 linked to the vehicle transmission and a second end 180 linked to the selector lever assembly 20. The driving lever 160 is linked to the selector lever assembly 20 for the purpose of mechanically performing at least one of the shifting operations. In the example herein disclosed, said at least one of the shifting operations is the park shifting position P for locking the vehicle transmission. The remaining shifting operations, e.g. neutral N, drive D, manual mode M, reverse R, tip-up, tip- down, etc. are performed electrically through the selector lever 22. While said remaining shifting operations are performed electrically through the selector lever 22, the mechanical transmission device 150 is not actuated.

The driving lever 160 is linked to the vehicle transmission through the first end 170 by a cable 30. The cable 30 may be, for example, a push pull cable. A first end of the push pull cable 30 is linked to the driving lever 160. A second, opposite end of the push pull cable 30 is linked to the vehicle transmission. In the particular embodiment shown, the second end of the push pull cable 30 is linked to the parking brake mechanism for locking the vehicle transmission.

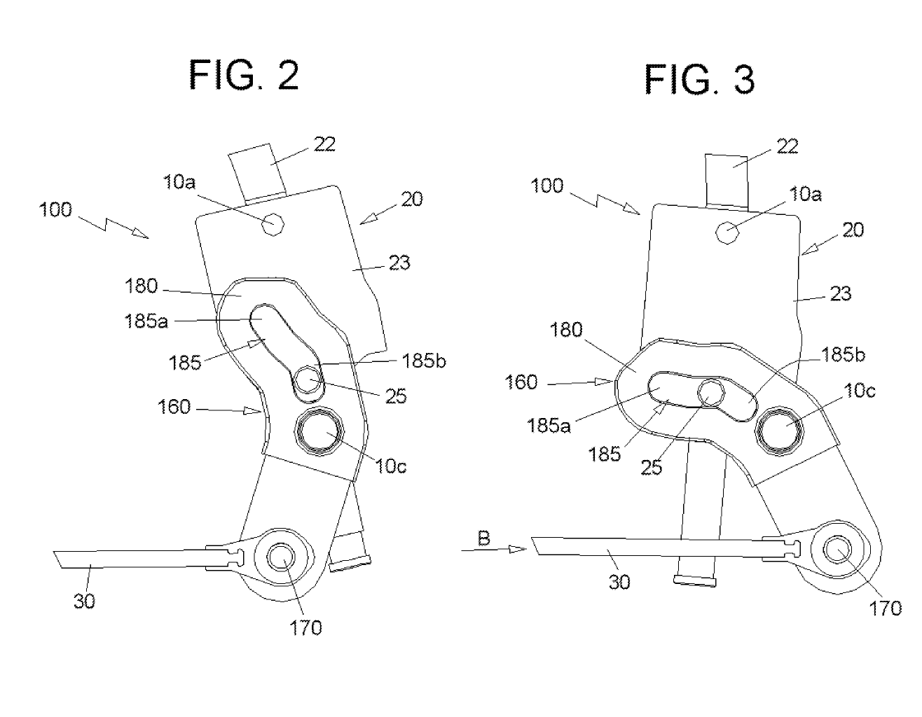

The cable 30 is allowed to be moved substantially in two opposite directions indicated by arrows A and B in FIGS. 2 and 3. The movement of the push pull cable 30 according to said directions A, B causes the gear transmission to be shifted (in this embodiment from park P to reverse R). A cable attachment 35 is fitted to the housing 10 for retaining the push pull cable 30 in position during operation of the cable 30, as shown in FIG. 1.

The driving lever 160 is allowed to be rotated around a shaft 10c. Shaft 10c is linked to a fixed part of the gearshift device 100.

The second end 180 of the driving lever 160 includes a shaped groove 185. The shaped groove 185 has two different groove sections 185a, 185b such that at least two different travels can be performed by the selector lever assembly 20 when the selector lever 22 is actuated by the user, as it will be explained hereinbelow.

A pin 25 may be formed integrally with the selector lever assembly 20, that is, the bracket 23. Alternatively, the pin 25 may be a separate part attached to the bracket 23. The groove sections 185a, 185b of the shaped groove 185 are shaped and sized for receiving the pin 25 of the selector lever assembly 20, The pin 25 is capable of moving inside the groove sections 185a, 185b of the shaped groove 185 when the selector lever assembly 20 is actuated, causing the driving lever 160 to be rotated.

The two groove sections 185a, 185b of the shaped groove 185 are inclined to each other as shown in the FIGS. 1-3 of the drawings. The particular configuration of the groove sections 185a, 185b of the shaped groove 185 in the embodiment shown is such that the first groove section 185b is substantially inclined to the horizontal when the selector lever assembly 20 is in the park shifting position P, as shown in FIG. 2. Relative inclination of the groove sections 185a, 185b, particularly the first groove section 185a, is such that in a first travel of the selector lever assembly 20 the pin 25 of the selector lever assembly 20 starts moving as the selector lever 22 is actuated by the user through the first groove section 185a inside the shaped groove 185 towards the second groove section 185b. Movement of the pin 25 along the inclined first groove section 185a causes the pin 25 to urge the inner wall of the first groove section 185a. This in turn causes the driving lever 160 to be rotated according to the shaft 10c resulting in that the device 100 is moved into the reverse shifting position R through actuation of the selector lever 22 by the user. The pivotal movement of the driving lever 160 causes the cable 30 to be actuated so it is moved in a pull direction as depicted by arrow B in FIG. 3. The travel distance of the cable 30 in said pull direction B is required for moving the gear transmission from one shifting position to another, in this particular case from park P to reverse R, as stated above.

The pin 25 of the selector lever assembly 20 continues moving along the second groove section 185b of the shaped groove 185 according to a second travel of the selector lever assembly 20. When performing this movement, the inner wall of the second groove section 185b is not urged by the pin 25 since the second groove section 185b is substantially horizontal due to the above mentioned pivotal movement of the driving lever 160. At this time, and as shown in FIG. 3, the cable 30 has been already moved and no further movement of the cable 30 occurs even the pin 25 still moves along the second groove section 185b. Therefore, no movement of the cable 30 is produced in the following shifting operations when actuating the selector lever 22. It is important to note that when the cable 30 is actuated from park P to reverse R and vice versa, the remainder shifting positions are electronically controlled while the cable 30 remains stationary, that is, arranged in a locked position. In the remainder positions (N-D), that is, in shifting operations other than those involving park P and reverse R, and during the movement of the selector lever 22, the cable 30 remains locked such that it can not be moved according to arrows A, B. This is because of the driving lever 160 is locked, i.e. it is not allowed to be pivoted, due to the position of the pin 25 within the shaped groove 185.

From the above described shifting position (park P to reverse R), when for example shifting into the drive shifting position D, no movement of the cable 30, according to arrows A, B, will be now allowed as stated above. The cable 30 remains locked in the reverse shifting position R. Likewise, when shifting from drive D to manual shifting position M the same occurs, that is, the cable 30 remains stationary and the shifting positions may controlled electronically.

It has been found that this gearshift device 100 as disclosed is capable of efficient electronic actuation for shifting operations while being capable of cable actuation between park P and reverse R shifting positions.

Although only a number of particular embodiments and examples of the present device have been disclosed herein, it will be understood by those skilled in the art that other alternative embodiments and/or uses and obvious modifications and equivalents thereof are possible. For example, the position of the shaft 10c for pivotal movement of the driving lever 160 could be varied such that the cable 30 could be actuated in a push direction A instead of the pull direction B as shown in FIG. 3. On the other hand, the shaped groove 180 could be formed in another part other than the second end of the driving lever. On the other hand, the shift position P could be also electrically detected for example for outputting a signal to the driver indicating that such shift position P has been activated.

Reference signs related to drawings and placed in parentheses in a claim, are solely for attempting to increase the intelligibility of the claim, and shall not be construed as limiting the scope of the claim. Furthermore, the claims cover all possible combinations of the particular embodiments described, so the scope should not be limited by particular embodiments, but should be determined only by a fair reading of the claims that follow.

1. A shift-by-wire gearshift device for an automatic vehicle transmission, the device comprising:
a pivotable selector lever assembly for performing shifting operations for controlling the vehicle transmission, said shifting operations involving a plurality of shifting positions of the lever assembly;
an electronic transmission device linked to the selector lever assembly for determining the shifting operations; and
a mechanical transmission device linked to the selector lever assembly and the vehicle transmission for mechanically performing at least one of the shifting operations;
wherein the mechanical transmission device comprises a driving lever linked to the vehicle transmission and to the selector lever assembly, and,
wherein whereby in a first travel of the selector lever assembly the driving lever is adapted to operatively perform said at least one shifting operation when the selector lever assembly is actuated, and in a second travel of the selector lever assembly the driving lever does not perform said at least one shifting operation when the selector lever assembly is actuated, while allowing the remainder shifting operations to be performed.

2. A gearshift device as in claim 1, wherein said at least one shifting operation that is not performed by the driving lever when the selector lever assembly is actuated at least corresponds to a Park shifting position for locking the vehicle transmission.

3. A gearshift device as in claim 1, wherein the driving lever includes a shaped groove and the selector lever assembly includes a pin, the shaped groove being adapted to receive the pin such that it can be moved therethrough, the shaped groove having a first section shaped such that the driving lever is adapted to operatively perform said at least one shifting operations, and a second section shaped such that the driving layer is not capable of performing the at least one shifting operation while allowing the remainder shifting operations to be performed.

4. A gearshift device as in claim 2, wherein the driving lever includes a pin and the selector lever assembly includes a shaped groove, the shaped groove being adapted to receive the pin such that it can be moved therethrough, the shaped groove having a first section shaped such that the driving lever is adapted to operatively perform said at least one shifting operation, and a second section shaped such that the driving lever is not capable of performing the at least one shifting operation, while allowing the remainder shifting operations to be performed.

5. A gearshift device as in claim 1, wherein one end of the driving lever is linked to the vehicle transmission through a cable for mechanically performing said at least one shifting operation.

6. A gearshift device as in claim 5, wherein said end of the driving lever is pivotally attached to one end of the cable for mechanically performing said at least one shifting operation.

7. A gearshift device as in claim 6, wherein the cable linking the driving lever to the vehicle transmission is a push-pull cable.

8. A gearshift device as in claim 1, wherein the device comprises a housing having at least two shift axes and the selector lever assembly comprises a selector lever and a bracket pivotally mounted about at least one of the shift axes of the housing.

9. A gearshift device as in claim 8, wherein at least one of said shift axes is arranged such that rotation of the selector lever assembly to the housing causes rotation of the driving lever around shaft and the actuation of the cable when the pin is moved inside the first section of the shaped groove.

10. A gearshift device as in claim 1, wherein the driving lever is made of a single piece.

11. A gearshift device as claimed claim 3, wherein the driving lever includes a pin and the selector lever assembly includes a shaped groove, the shaped groove being adapted to receive the pin such that it can be moved therethrough, the shaped groove having a first section shaped such that the driving lever is adapted to operatively perform said at least one shifting operation, and a second section shaped such that the driving lever is not capable of performing the at least one shifting operation, while allowing the remainder shifting operations to be performed.

12. A gearshift device as in claim 1, wherein the shifting operations comprise at least Park, Drive, Neutral and Reverse.
